(19) United States
(12) Patent Application Publication
(10) Pub. No.: US 2009/0265055 A1
(43) Pub. Date: Oct. 22, 2009

(54) SYSTEM AND METHOD FOR PERFORMING AUTOMOTIVE DIAGNOSTICS

(76) Inventor: Winston Lynn Gillies, Sandy, UT (US)

Correspondence Address: Floris Chad Copier, 5373 W. 10480 N., Highland, UT, 84003, US

(21) Appl. No.: 12/104,433

(22) Filed: Apr. 17, 2008

(51) Int. Cl. G01M 17/00

(52) U.S. Cl. 701/29

(57) ABSTRACT

This application describes and discloses diagnostic systems, methods, and associated devices for repairing vehicles. A hand-held interface device configured to wirelessly communicate with a wireless OBD device in a vehicle to be repaired with bi-directional control. A network access point and other wireless devices may be used to access vehicle information, repair instruction, diagnostic information, research information, remote expert guidance, remote databases and applications, and other repair and diagnosis information from the interface device, allowing a technician to efficiently and effectively repair a vehicle.

### PRIORITY

This application claims priority to U.S. Provisional Patent Application No. 60/912,099 filed Apr. 16, 2007, which in incorporated herein by reference in its entirety.

### FIELD

The invention generally relates to the field of automotive diagnostics and repair. In particular, the invention relates to a system that allows real-time bi-directional diagnostics of a vehicle from a wireless hand-held or otherwise portable device.

### BACKGROUND

Over the last several years, the automotive repair industry has seen a steady decline in people choosing to become automotive repair technicians. Even local high schools have dropped automotive repair from their curriculum. Additionally, the automotive repair industry has suffered from the stigma associated with filth and low pay. People think that because you work with your hands, you can't make as much as someone in a white collar job.

Along with the shortage of new technical talent comes the problem of age and retirement in the automotive industry. The master technicians on the job today are getting older and physically less capable of the strenuous requirements associated with automotive repair.

Experience is needed to create billable hours with timely completion of repair tickets. In the case where the master-mechanic is still supporting the shop he is associated with, he is required to do two things; 1) leverage his expertise to create as much billable work as possible, and 2) act as a technical advisor to the apprentice technicians on his shop floor.

Over time, automobiles have become increasingly difficult to troubleshoot and repair. With the addition of sensors and controllers to every aspect of the automobile comes the need for the technical expertise to keep them running properly. Without sufficient skills, experience, and technical ability it is virtually impossible to function as an auto mechanic in today's environment. Today's automotive technician combines the expertise of yesterday's mechanic with those of today's computer support technician. Training is intense and never-ending.

With added technical complexity comes the need for multiple data resources. Information is supplied to the technician through a myriad of channels such as the manufacturer, and other data subscriptions. Once a symptom or issue is discovered, the technician may be required to research troubleshooting and repair procedures in more than one resource to correct the problem for his customer. Due to systems complexity, the average research time, industry wide, is two-and-a-half hours.

Compounding the problem, the technology required to diagnose and repair today's automobiles is very costly. The technician is required to undergo extensive training in order to use the tools properly. Since new makes and models of both vehicles and diagnostic tools are manufactured yearly, there is a continuing requirement to purchase additional software updates and upgrades for the new models being released. Cost for those updates and upgrades can be significant for each annual release. If a shop overlooks the need to upgrade or update, or decides to wait, it is not able to troubleshoot or repair any of the vehicles manufactured in that new release year. In that case, the shop would turn business away to someone else that has the troubleshooting and repair capability they neglected to purchase.

Along with diagnostic software upgrades and updates, there is another cost associated with diagnosing and repairing today's automobiles. That cost is the renewal of data subscriptions for web-enabled and CDROM delivered research databases. If the shop neglects to update their subscription, they no longer have access to updated information for existing model years as well as new model releases. Again, the shop would have to refer the customer to another technician with current data access capability to resolve their technical issues.

Currently, all automobile manufacturers are only concerned with the information and diagnostic capability that pertains to their products. However, a majority of shops that are currently in business work on multiple automobile manufacturer's products and rarely focus on any single offering. With that in mind, the diagnostic and support tools that exist are typically designed around a single product line. For a shop to have the capabilities that are required to support its customers industry wide, they have to purchase a tool from each of the manufacturers, train technicians in its proper use, and pay for the software updates and upgrades as required. Since one manufacturer's system is not designed for any other manufacturer's product, each tool offered is lacking in its ability to be used for anything else.

### SUMMARY

This application describes and discloses diagnostic systems, methods, and associated devices for repairing vehicles. A hand-held interface device configured to wirelessly communicate with a wireless on-board diagnostic (OBD) device in a vehicle to be repaired with bi-directional control. A network access point and other wireless devices may be used to access vehicle information, repair instruction, diagnostic information, research information, remote expert guidance, remote databases and applications, and other repair and diagnosis information from the interface device, allowing a technician to efficiently and effectively repair a vehicle.

These and other aspects of the present invention will become more fully apparent from the following description and appended claims.

### BRIEF DESCRIPTION OF THE DRAWINGS

The following description can be better understood in light of Figures, in which:

FIG. 1 is a schematic representation of a diagnostic system according to an embodiment of the invention;

FIGS. 2 is a flowchart of a diagnostic method according to an embodiment of the invention;

FIG. 3 is a flowchart of a diagnostic method according to an embodiment of the invention;

FIG. 4 is a flowchart of a diagnostic method according to an embodiment of the invention;

FIG. 5 is a flowchart of a diagnostic method according to an embodiment of the invention; and

FIG. 6 is a flowchart of a diagnostic method according to an embodiment of the invention.

Together with the following description, the Figures demonstrate and explain the principles of exemplary automotive diagnostic systems and associated apparatus and methods. In the Figures, the thickness and configuration of components may be exaggerated for clarity. The same reference numerals in different Figures represent the same component.

### DETAILED DESCRIPTION

In the illustrated embodiments, aspects and features of automotive diagnostic system and associated apparatus and methods are disclosed and described below.

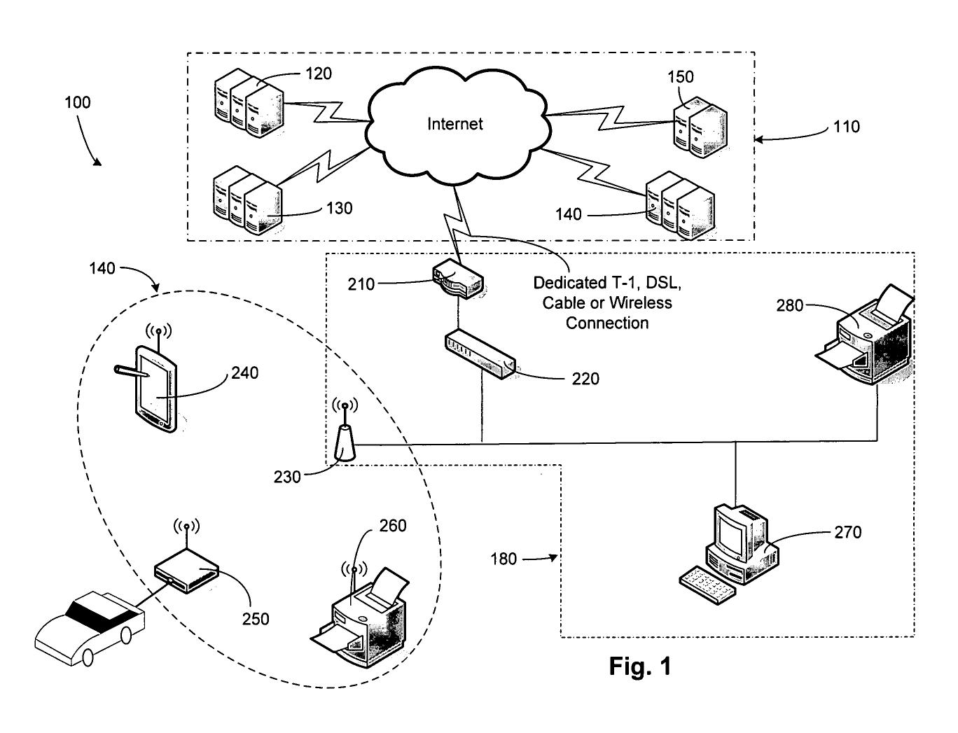

FIG. 1 illustrates an embodiment of system 100 for automotive diagnosis and repair. System 100 may allow individual automotive technicians to access database knowledge and information from network 110, which may include data access servers 120, automated research servers 130, live support servers 140, and merchant services processing servers 150. Individual technicians may use access tools 140 and local system 170 to access network 110. Each of access tools 140 may each wirelessly access and communicate with each other either directly or through wireless access point 230. Access tools 140 may include technician interface 240, wireless access point 230, wireless OBD interface 250, and wireless printer 260.

Local systems 180 may include one or more computers 270, printers 280 and wireless access points 230 connected to switch 220 and router 210. In some embodiments, computer 270, printer 280 and wireless access points 230 may be connected with communications cable or may be wirelessly connected. Similarly, switch 220 and router 210 may be in a single physical unit. Router 210 may provide access to network 110 and may be a modem or other internet access device or system. In some embodiments, local systems 180 may include all the software functionality as access tools 140, and may be used to display or evaluate information being collected or otherwise associated with access tools 140.

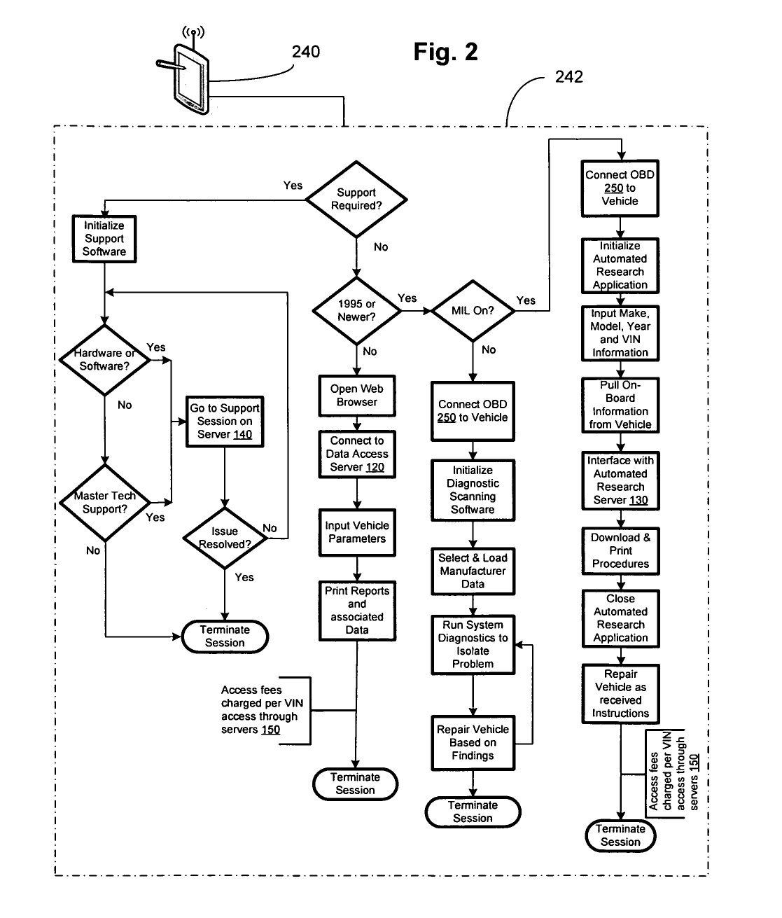

FIG. 2 includes flow diagram 242 for the functioning of interface 240. Interface 240 may include code or otherwise be configured to implement process 242. Interface 240 may also be a hand-held portable device such as a PDA, personal computer, tablet computer, data input and display device, notebook computer, or any other data communications device that may be connected wirelessly to other access tools 140 and/or local systems 180. In alternative embodiments, interface 240 may perform the steps of flow diagram 242, or may facilitate access by a technician to information provided by the process performed in flow diagram 242 by another component of system 100.

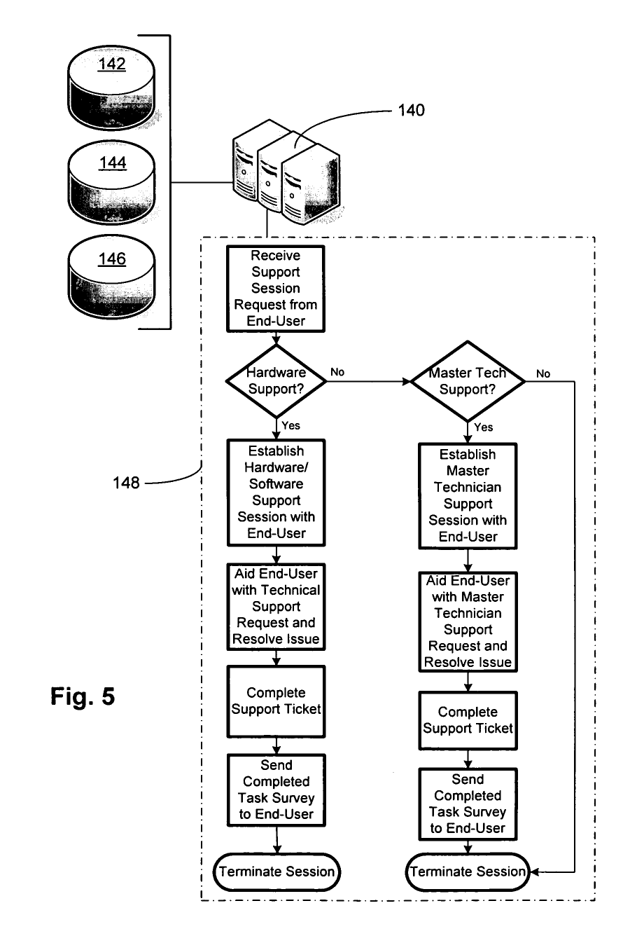

Interface 240 may allow a technician to identify, or may automatically identify by communication with other components of access tools 140 or system 100, the need for required support when diagnosing a vehicle for repair. For example, in some embodiments as shown in FIG. 2, need for support may be identified, such as if additional diagnostic help for a particular problem is required by the technician using interface 240. If additional support is required, a support software module may be initialized and a support session may be commenced in communication with live support servers 140, which may include real-time interaction with a master technician as further discussed below with respect to FIG. 5.

If there is no need for specialized support, technician using interface 240 may access data access servers 120 to research diagnosis and repair procedures for vehicles without a OBD (such as vehicles manufactured prior to 1995), or may attach OBD 250 to the vehicle being diagnosed and repaired. In some instances, the vehicle may identify itself to interface 240 through a wireless connection between OBD 250 and interface 240 or the information may be input by the technician. In some instances if a mechanical indicator light (MIL) is on and/or any indication of a fault code or pending fault code is detected from OBD 250, an automated research application may be used through interface 240 to communicate with automated research server 130 to determine the problem that needs to be repaired and the procedures for repairing the problem. In some embodiments, information on the problem may be printed at wireless printer 260, which may be located close to or at the vehicle being repaired.

In other instances, no fault code or MIL may be present to help diagnose and identify a problem being experienced with the vehicle being repaired. In such instances, interface 240 may be used to run system diagnostics to identify and isolate the problem to be repaired. This procedure may be repeated until the problem with the vehicle is cured.

In some embodiments, merchant services processing servers 150 may be automatically notified of access to different servers 120, 130, 140, resulting in access fees being charged to an account associated with interface 240 or the technician. In some embodiments, a credit card on may be charged for the access or a charge may be added to a bill for monthly or other periodic billing. In some embodiments, access may be charged per VIN identified, or for each problem identified. The technician or shop associated with interface 240 may then be billed or charged for an identified transaction based on the VIN or other transactional information.

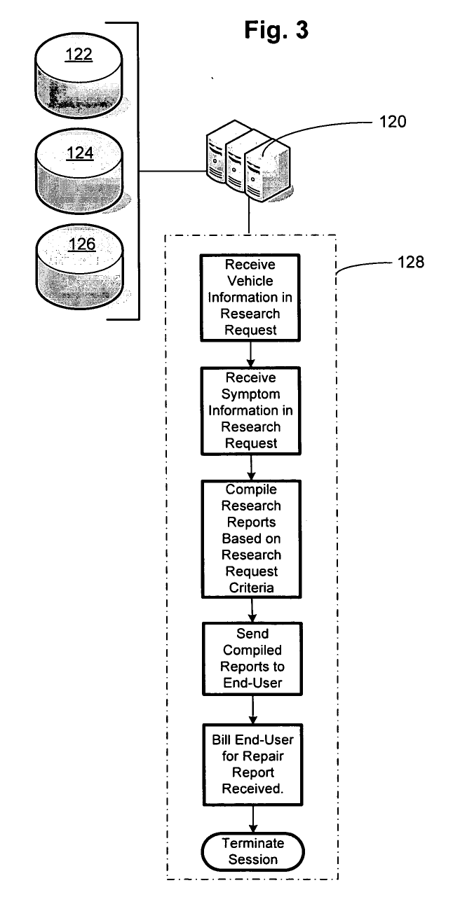

FIG. 3 illustrates data access servers 120, which may include several databases such as vehicle database 122, repair database 124, labor rates estimation tools database 126, etc. Different components of system 100 in cooperation or communication with interface 240 and data access servers 120 may perform the steps of flow diagram 128, or may facilitate access by a technician to information controlled by data access servers 120 and through the process performed in flow diagram 128 by another component of system 100.

For example, in some embodiments, data access servers 120 may receive vehicle information through a research request from a technician or automatically from interface 240 if such information is required to perform a function running in association with interface 240. Data access servers 120 may receive symptom information in the research request and compile research reports based on the research request criteria. A compiled report may be sent or otherwise provided to the technician or interface 240, and the billing information may be generated and sent to merchant services processing servers 150 for payment processing.

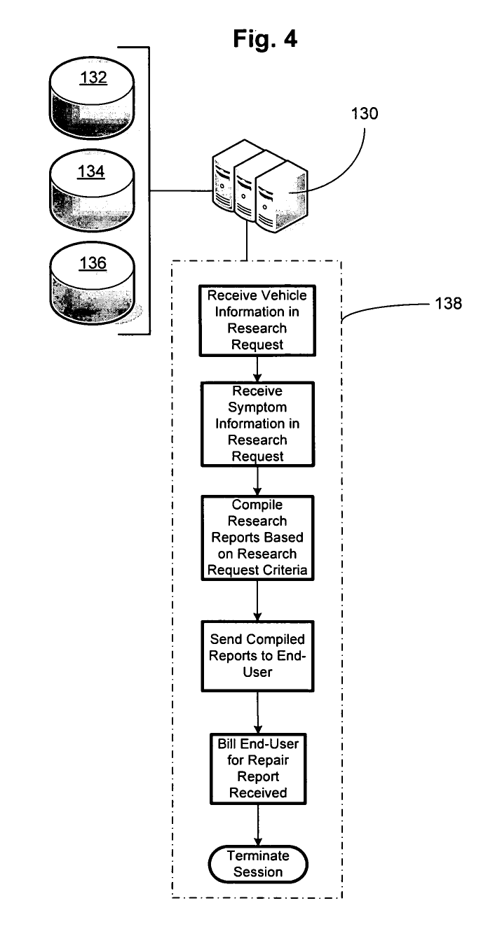

FIG. 4 illustrates automated research servers 130, which may include several databases or database pointers such as database pointers 132 based on AAIA and manufacturing reference numbers, repair database 134 containing dynamic database of completed repairs and quick fixes, OEM information database 136, other data access databases, etc. Different components of system 100 in cooperation or communication with interface 240 and automated research servers 130 may perform the steps of flow diagram 138, or may facilitate access by a technician to information controlled by automated research servers 130 and through the process performed in flow diagram 138 by another component of system 100.

For example, in some embodiments, automated research servers 130 may receive vehicle information through a research request from a technician or automatically from interface 240 if such information is required to perform a function running in association with interface 240. Automated research servers 130 may receive symptom information in the research request and compile research reports based on the research request criteria. A compiled report may be sent or otherwise provided to the technician or interface 240, and the billing information may be generated and sent to merchant services processing servers 150 for payment processing.

In some embodiments, a research tool software module may be used with interface 240 to speak to the on-board automotive system through OBD 250 to discover stored codes in memory, or codes that have caused the “check engine” or “service engine soon” MILs to illuminate. Those codes may captured and immediately forwarded to Automated research servers 130 through system 100, along with specific vehicle information such as make, model, year and VIN information. Automated research servers 130 may then compile all relevant diagnostic and repair information such as; test procedures, repair procedures, component locators, wiring diagrams, and technical service bulletins and forwards those to the included shop printer 260. Other information from automated research servers 130 and associated databases regarding quick fix recommendations, component degradation and forecasting, as well as vehicle use history may also be included in the final report.

FIG. 5 illustrates live support servers 140, which may include several databases and software modules such as end-user database 142, call queue management engine 144, reporting and survey database 146, other databases and software, etc. Different components of system 100 in cooperation or communication with interface 240 and live support servers 140 may perform the steps of flow diagram 148, or may facilitate access by a technician to information controlled by live support servers 140 and through the process performed in flow diagram 148 by another component of system 100. End-user database 142 may contain data for each technician or repair shop including all prior repairs, the technical expertise of the end-user, and personal information to enable a Master Technician to quickly and effectively help the end-user as needed.

For example, in some embodiments, live support servers 140 may receive a support session request from a technician through interface 240 as discussed above with respect to FIG. 2. Live support servers 140 may facilitate communication with a technician or other end-user and a live individual to help solve particularly difficult problems or problems that do not lend themselves to solutions using software or information alone. In some embodiments, live support servers 140 may prompt interface 240 to determine if hardware/software support for system 100 is needed or if support from a master technician is needed. If hardware/software support is needed, a support session is established to resolve the issue and a resolution or complete support ticket is generated and may be forwarded to the end-user. Similarly, if master technician help is required, a support session is established to resolve the issue and a resolution or complete support ticket is generated and may be forwarded to the end-user once the problem is resolved. Billing information may be generated and sent to merchant services processing servers 150 for payment processing.

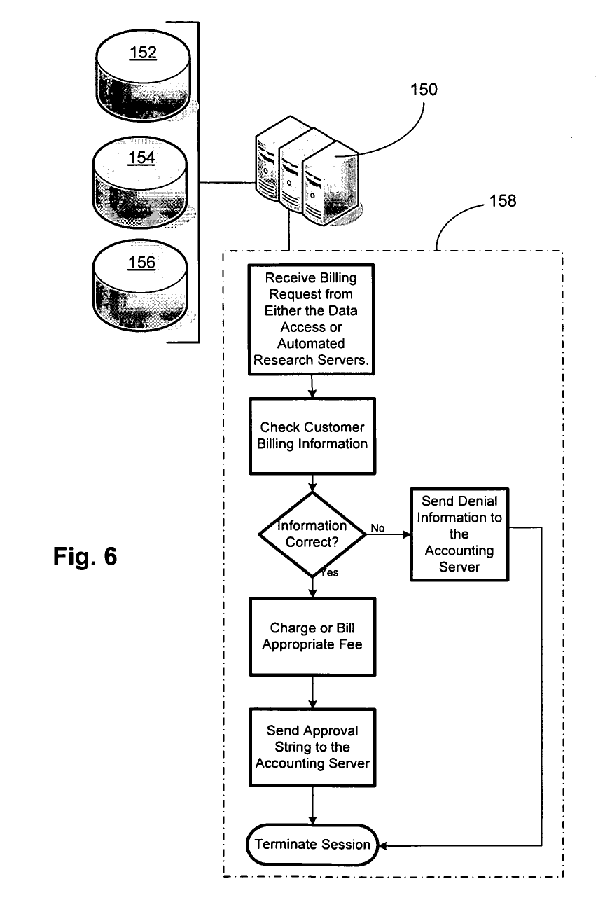

FIG. 6 illustrates merchant services processing servers 150 which may include several databases and software modules such as web interface application 152, credit card and customer information database 154, reporting database 156, other billing databases, etc. Different components of system 100 in cooperation or communication with interface 240 and merchant services processing servers 150 may perform the steps of flow diagram 158.

For example, merchant services processing servers 150 may receive a billing request from data access servers 120, automated research servers 130, live support servers 140, interface 240, or another component of system 100. Customer information such as billing data, credit card information, billing addresses, etc. may be verified, followed by either a denial of service sent back to the appropriate component or server of system 100, or a billing or charge entry being generated.

Having described system 100 and the functionality of system 100 and various components of system 100. System 100 may provide several tools to a technician in the diagnosis and repair of automobiles. For example, the following tools may be incorporated into system 100.

1. Bi-Directional Automotive Diagnostic and Control Software—this package may allow interface 240 or system 100 to talk directly to the on-board automotive system through OBD 250 and allows the technician to download trouble code information, control system components such as actuators and solenoids, and to view real-time graph and digital readings for internal system performance and proper component functionality. This utility creates a simple, easy-to-use interface between the automotive technician and the vehicle, such as a car, truck or commercial vehicle being worked on.

2. Data Logger—A data logger may be a physical component of system 100, or may be data storage associated with a component of system 100, allowing the technician to record occurrences of intermittent problems with a particular vehicle that may not be evident at the shop. For example, a vehicle may have a data logger placed in the vehicle being diagnosed during normal used to identify and record problematic vehicle performance. The recorded data may then be uploaded into system 100 for review and analysis to determine the best possible course of action to resolving tricky, intermittent problems.

3. PC Scope—at times, it may be necessary to take voltage readings and check waveforms across certain components within a vehicle being repaired. The PC scope may be also included as software or a separate hardware component in system 100, and may act as an oscilloscope, allowing waveforms to be viewed and compared to pre-recorded waveforms in a waveform library associated with one of the databases 120, 130, 140, or with information stored on computer 270, interface 240, or another component of system 100. Use of a PC scope may help the technician to decrease the amount of time required to troubleshoot an electrical issue. By making comparisons between actual readings from a PC scope and stored counterpart waveforms within system 100, component level problems may be accurately pinpointed and resolved.

4. Flash Reprogrammer—sometimes it may be necessary to reprogram a vehicle computer to clear out software glitches or other software failures that have occurred over time. A flash reprogrammer may be a software module installed on interface 240 or any other component of system 100, providing a simple, easy-to-use utility for solving some problems.

5. Training and Test Preparation—System 100 may help entry level technicians by providing them with the information they need to be proficient at their jobs without a master technician on-site or standing over their shoulder at all times. If certification is the goal, system 100 may provide in-depth data and practice examinations to help the technician increase in knowledge, proficiency, and earning potential. Training may be available through system 100 and may be done either at the shop or after hours at home using account access information through the internet

6. Master Technician Support—every shop, dealership, or repair facility should have at least one master technician. The master technician is usually the moneymaker for the shop because of their level of expertise and years of experience allowing junior technicians to be efficient in solving problems. As discussed above, live mater technician support may be provided through system 100 to a technician as needed. As the need arises, a master technician takes control of access tools 140 remotely and aids the on-site technician in finding the correct course of action as efficiently as possible. Because of the interaction between the remote master technician and the technicians of a shop utilizing system 100, the shop may become more productive without adding additional overhead and personnel.

Having described the preferred aspects, it is understood that the invention defined by the appended claims is not to be limited by particular details set forth in the above description, as many apparent variations thereof are possible without departing from the spirit or scope thereof.

What is claimed is:

1. An automotive diagnostic system, comprising:
a wireless interface device configured to diagnose problems in a vehicle;
an automotive interface device configured to be coupled to the vehicle and communicate wirelessly with the wireless interface device; and
a wireless access point configured to communicate with at least one of the wireless interface device and the automotive interface device, and further configured to communicate with at least one remote server.

2. The system of claim 1, wherein the wireless access point is in wired communication with at least one computer and an internet connection device.

3. The system of claim 2, wherein the system is configured to provide training to a technician through at least one of the wireless interface device, the computer, or a remote computer accessing the at least one database through an internet connection.

4. The system of claim 1, wherein the at least one remote server is selected from a data access server, an automated research server, a live support server, and a merchant services server.

5. The system of claim 3, wherein the at least one remote server controls access to at least one database selected from a vehicle database, repair database, OEM information database, dynamic repair database, end-user database, and reporting database.

6. The system of claim 5, wherein the wireless interface device is configured to provide information from the at least one remote server to a technician working on the vehicle.

7. The system of claim 1, further comprising a wireless printer configured to be located proximate to the vehicle.

8. The system of claim 1, wherein the automotive interface device is an OBD device, and wherein the OBD device is configured to wirelessly communicate vehicle information and provide control of vehicle systems to the wireless interface device.

9. The system of claim 1, further comprising a data logger configured to collect data associated with the vehicle and communicate with the wireless interface device.

10. The system of claim 1, further comprising a PC scope configured to capture and/or display waveforms associated with at least one electrical component of the vehicle, and wherein the at least one remote server is configured to provide model waveforms, and wherein the wireless interface device is configured to display a comparison of the waveforms associated with the at least one electrical component of the vehicle and at least one model waveform.

11. The system of claim 1, further comprising a flash reprogrammer configured to reprogram at least an electronic controller on the vehicle through the wireless interface.

12. A method of diagnosing a vehicle, comprising:
establishing bi-directional wireless communication between a portable device and the vehicle;
providing operating information from the vehicle to the portable device;
communicating the operating information to at least one remote server wirelessly from the portable device; and
receiving at least one of diagnostic information and repair information from the at least one remote server.

13. The method of claim 12, further comprising:
controlling at least one component of the vehicle from the portable device; and
determining the functioning of the at least one component based on the controlling.

14. The method of claim 12, wherein the at least one remote server is one of a data access server, an automated research server, a live support server, and a merchant services server.

15. The method of claim 14, wherein the receiving includes communication with a remote master technician.

16. The method of claim 12, wherein the receiving includes data compiled from previous repairs of vehicles similar to the vehicle.

17. The method of claim 12, wherein the receiving is performed at least by a printer in wireless communication with the at least one remote server.

18. The method of claim 12, wherein the providing information to the portable device includes at least fault codes stored in a controller in the vehicle.

19. The method of claim 12, further comprises running diagnostic software on the portable device to diagnose problems in the vehicle.

20. The method of claim 12, further comprising providing an OBD in wired communication with the vehicle and configured to be in wireless communication with the portable device.
